(19) United States
(12) Patent Application Publication
(10) Pub. No.: US 2009/0239552 A1
(43) Pub. Date: Sep. 24, 2009

(54) LOCATION-BASED OPPORTUNISTIC RECOMMENDATIONS

(75) Inventors: Elizabeth Churchill, San Francisco, CA (US); Shyong (Tony) Lam, Richfield, MN (US); Joseph O'Sullivan, Oakland, CA (US)

Correspondence Address: YAHOO C/O MOFO PALO ALTO, 755 PAGE MILL ROAD, PALO ALTO, CA, 94304, US

(73) Assignee: YAHOO! INC., Sunnyvale, CA (US)

(21) Appl. No.: 12/054,305

(22) Filed: Mar. 24, 2008

(51) Int. Cl. H04Q 7/20

(52) U.S. Cl. 455/456.3

(57) ABSTRACT

Location aware notification service technology operable to provide users with notification of opportunities to complete errands on a personal sharable list is disclosed. The location aware notification service technology provides a means for generating recommendations for users for the successful completion of errands based upon current location, time and travel context.

### FIELD OF THE INVENTION

The present invention relates generally to internet communication and more particularly to internet community communication.

### BACKGROUND OF THE INVENTION

There are many circumstances when people unexpectedly have extra time on their hands. Often people find themselves in unexpected places or stuck en-route to a destination, for example, in traffic, after a cancelled flight, or waiting for delayed public transport. There is currently a limited choice of tools available for task management in unexpected situations.

Existing tools include personal task management products, collaborative task management products, and location aware reminder systems. An internet service system supports getting errands done (see FIG. 1), including getting reminded by mobile devices through email, short message service (SMS) and instant messaging (IM). It also provides a mapping tool so that users can plan routes. However, it does not include any form of system recommendation alerts based on the user's geo-location and current trajectory.

Currently, there are few tools to help a person re-plan to “get things done” during wait times. Time saved by performing tasks during wait times may be of great value. Therefore, there is a need for systems and methods that help with re-planning.

### SUMMARY OF THE INVENTION

Location time and social context sensitive notification service technology operable to provide users with notification of opportunities to complete errands that may be on a personal list is disclosed. The location sensitive notification service technology provides a means for recommending errands that can be done based on current location and travel context.

A first embodiment of the invention comprises a time and location-based opportunistic errand handling and targeted shopping recommendation system. The system comprises a database of errands, where the errands relate to errands to be performed by a user. The system also includes a server for sending notification to a user device in response to the user device being in a suitable proximity to a location where an errand may be performed.

A second embodiment of the invention comprises a method for location-based opportunistic errand handling and targeted shopping recommendations. The method comprises obtaining a location of a user device and detecting proximity to locations indicated by location data stored in an errand database. If the user device is near a location indicated by the location data stored in the errand database, then the system notifies the user device of errands that may be performed at the current location.

A third embodiment of the invention comprises a computer-readable medium comprising program code for providing location-based opportunistic errand handling and targeted shopping recommendations. The computer-readable medium also comprises program code for obtaining a location of a user device and detecting proximity to locations indicated by location data stored in an errand database. The computer-readable medium further comprises program code for notifying the user device of errands that may be performed at the current location based on the location data.

A fourth embodiment of the invention comprises an interface for presentation on a display. The interface comprises a listing of errands, wherein the interface is operable for management of the listing of errands. The interface further comprises a device registration interface operable for enabling at least one device to notify a user of errands that can be done at a location of the user based on the list of errands.

Further features and advantages of the invention, as well as the structure and operation of various embodiments of the invention, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an illustration of a current web page for remember the milk.

FIG. 2 is a block diagram illustrating a high level architecture of components of a location-based opportunistic errand handling and targeted shopping recommendations system in accordance with one embodiment of the invention.

FIG. 3 is an illustration of an exemplary location-based opportunistic errand handling and targeted shopping recommendations interface according to an embodiment of the invention.

FIG. 4 is block diagram illustrating an exemplary computer system that may be used in accordance with some embodiments of the invention.

FIG. 5 shows an exemplary flow diagram illustrating a location-based opportunistic errand handling and targeted shopping recommendations process in accordance with an embodiment of the invention.

FIG. 6 shows an exemplary flow diagram illustrating a process for entering shopping needs in a database in accordance with an embodiment of the invention.

FIG. 7 shows an exemplary flow diagram illustrating a recommendation alert process in accordance with an embodiment of the invention.

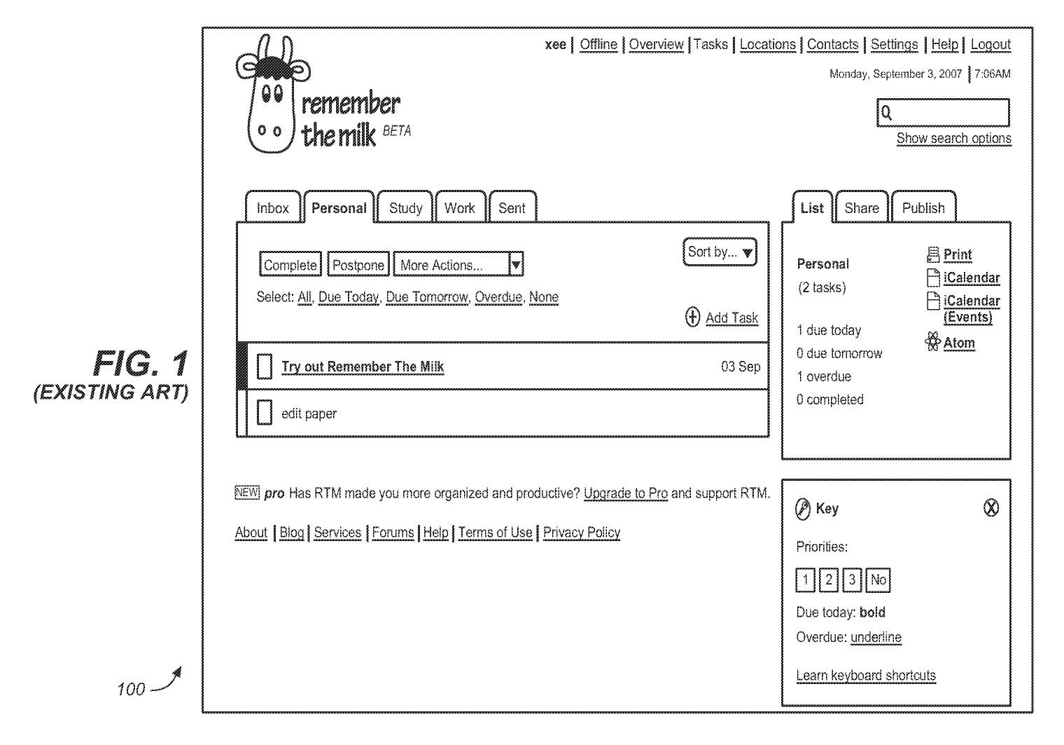

### DETAILED DESCRIPTION OF THE EXEMPLARY EMBODIMENTS

In the following description of exemplary embodiments, reference is made to the accompanying drawings which form a part hereof, and in which it is shown by way of illustration specific embodiments in which the disclosure may be practiced. It is to be understood that other embodiments may be utilized and structural changes may be made without departing from the scope of the exemplary embodiments of the invention.

The present disclosure is directed toward systems and methods for providing location-based opportunistic errand handling and targeted shopping recommendations to support both unexpected (and routine) situations. Embodiments of the invention are described herein in the context of one practical application, namely, shopping. Embodiments of the invention, however, are not limited to shopping applications, and the methods described herein may also be utilized in other applications such as location based route planning. As would be apparent to one of ordinary skill in the art after reading this description, these are merely examples and the invention is not limited to operating in accordance with these examples.

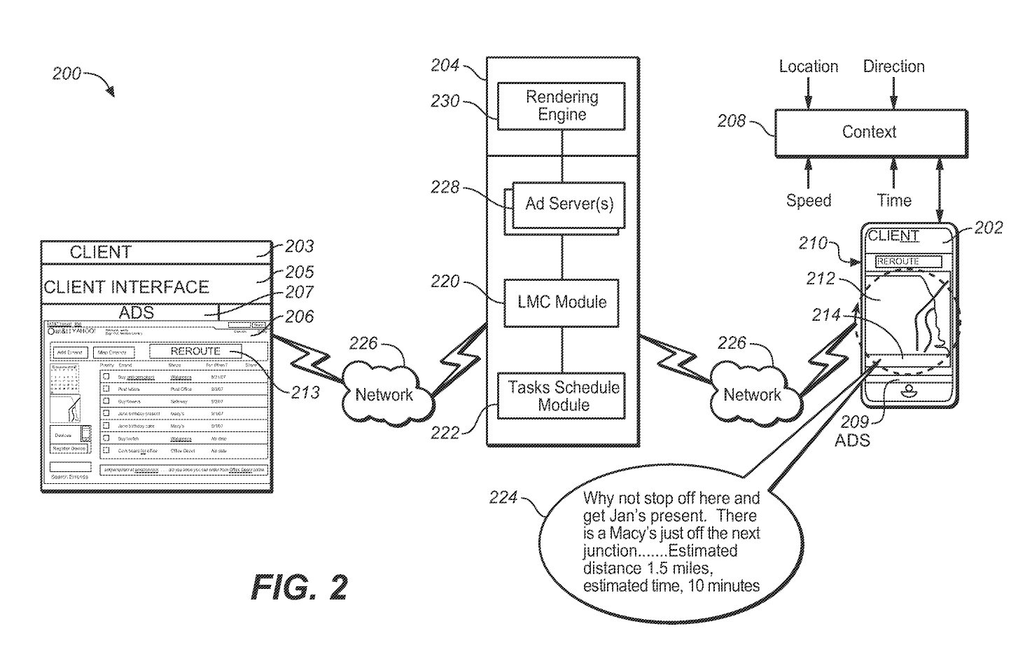

The basic system components are interface/interaction elements for desktop and mobile devices, and a set of integration components that combine information from several sources: the task/errand lists and timetables of users, current location and trajectory of users, local information regarding retailers in the user current location (e.g., from internet sources), mapping/routing information to calculate the route from the user's current location to that of the recommended retailer(s) (e.g., from internet sources), and travel information (e.g., traffic reports from internet sources). The system components are shown in FIG. 2.

FIG. 2 is a block diagram illustrating a high level architecture of components of a location-based opportunistic errand handling and targeted shopping recommendations system 200 in accordance with one embodiment of the invention. System 200 comprises clients 202 and 203, a server 204, and a user interface 206 that may be used to operate clients 202 and 203. The system operates in a context environment 208. Generally, the clients 202/203 (or a plurality of clients) may access the server 204 via a network 226.

The clients 202/203 and the server 204 according to the embodiments of the invention may include any one of various types of computer devices, having, e.g., a processing unit, a memory (including a permanent storage device), and a communication interface, as well as other conventional computer components (e.g., input device, such as a keyboard and mouse, and an output device, such as a display). For example, the client 202/203 may include user devices such as a desktop computer, laptop computer, mobile device such as a mobile phone, web-enabled phone, smart phone, and the like.

The clients 202/203 may communicate with the server 204 using suitable communication interfaces via the network 226, such as a wireless communication system or the Internet. The clients 202/203 and the server 204 may communicate, in part or in whole, via wireless or hardwired communications, such as Ethernet, IEEE 802.11b wireless, or the like. Additionally, communication between the clients 202/203 and the server 204 may include various servers such as a mail server, a mobile server, an add server, and the like.

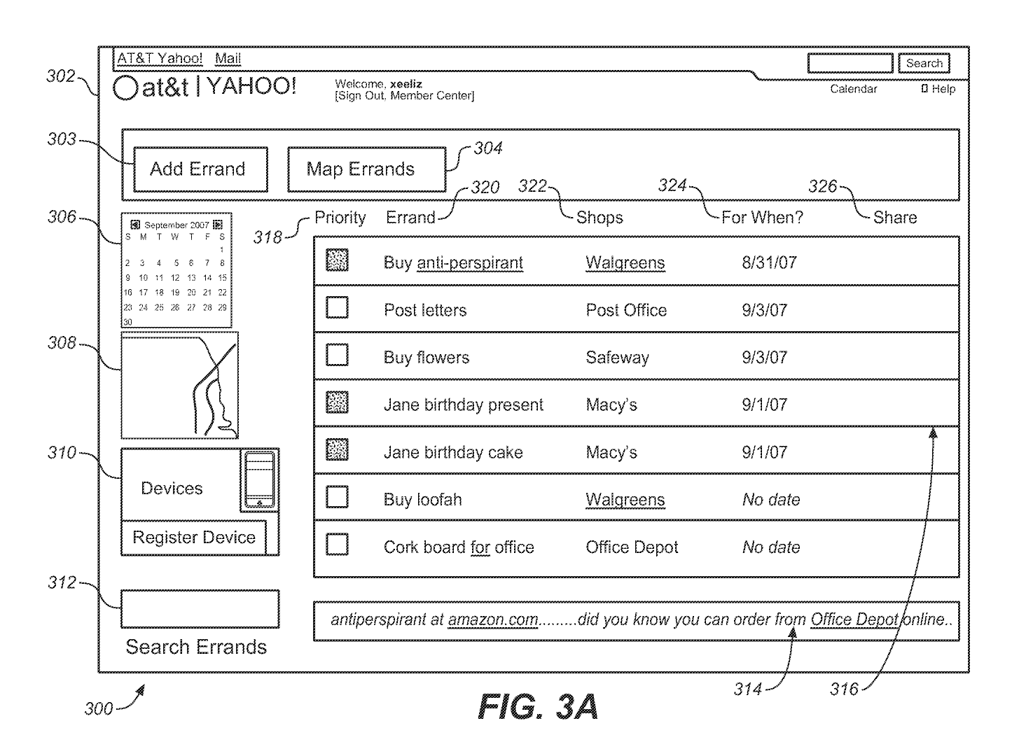

The clients 202/203 may comprise interfaces 205/210 which include a map webpage or component 212, a notification area or component 214, ad areas 207/209, and reroute buttons 213/215. The interfaces 205/210 are operable to accept user input (via input devices such as a mouse, keyboard, stylus, or touch screen) and to change the content, and/or the actions of components 212/214. The components 212/214 may also change content and/or actions at user specified predefined times. Contextual advertisement may be presented on the interfaces 205/210 in ad areas such as ads 207/209. The reroute buttons 213/215 are conditional buttons that can appear if an errand becomes available and is accepted for action. The reroute buttons 213/215 allow users to request a rerouting of a planned errand. The user can access and manipulate the interfaces 205/210 as explained in more detail in the context of discussion of FIG. 3. The clients 202/203 may comprise a mobile device such as a vehicle's navigation device, cell phone, PDA, or other devices including various types of displays. The interfaces 205/210 may be presented by a server 204 such as, for example, a website server. The interfaces 205/210 may be used by a user to utilize and operate the location-based opportunistic errand handling and targeted shopping recommendations system 200.

The server 204 may be programmed to format data, accessed from local or remote databases or other sources of data, for presentation to users of the clients 202/203, for example, in the formats discussed in detail below. The server 204 may utilize various Web data interface techniques such as the Common Gateway Interface (CGI) protocol and associated applications (or “scripts”), Java™ “servlets”, e.g., Java™ applications running on the server 204, or the like to present information and receive input from the clients 202/203. The server 204 may be implemented as, for example, a computer program, and may include a web server, e.g., Apache™ or the like. The server 204, although described herein in the singular, may actually comprise plural computers, programs, devices, backends, and the like, communicating (wired or wireless) and cooperating to perform the functions described herein.

The server 204 may be a centralized facility, or any or all of its various functions may be distributed across a plurality of facilities or locations in a geographically diverse manner. Further, the various functions described herein as attributable to a location-based opportunistic errand handling and targeted shopping recommendations system may be distributed to and among the various facilities serviced by server 204.

Server 204 may include: a Local Media Content module (LMC) 220 operable to monitor location, traffic, geographic information systems (GIS), transport schedules, maps, local retailer ads, web shopping, meta-data for store hours, and the like; a task schedule module 222 operable to schedule future errand tasks; additional servers such as ad servers 228 for providing advertising related to the errand and/or the location where the errand can be performed; and a rendering engine 230 that collates information from these sources and presents them on the clients 202/203. The Local Media Content and the user generated content (user data) in the form of tasks and schedules (and contacts as appropriate for collaborative errand handling), may be provided by the Local Media Content module 220 and the task schedule module 222 respectively to the mobile and/or desktop interfaces to provide the recommendations offered by the service (one is depicted in the speech bubble 224, which would be visible on the interfaces 205/210). The Local Media Content in the Local Media Content module 220 includes, but is not limited to, general data sources such as social graphs, locals, ratings and reviews, maps, shopping, GPS location information, and the respective APIs to each of these data sources. The tasks and schedules on task schedule module 222 includes, but is not limited to, the user(s) to do list, the user's devices, the current time, and the user profile and preferences the user has set in the system. The errands can be accomplished by multiple users, and the task schedule module 222 may include activity related to all the users. The users may include users in a community, individuals, dyads, small groups (e.g., families), and large groups all being able to share tasks (aka errands). The server 204 matches the tasks from task schedule module 222 to the local context 208 (from client 202) and notifies the user of tasks that may be performed in a location indicated by the local context 208 of client 202. The local context 208 may be generated from the mobile device (e.g., client 202), indicating location and movement of the user. Tasks and route planning are specified by the user at the user interface 206 using the interface 205 of the client 203 or from the interface 210 on client 202. Tasks, shopping schedules and routes can be replanned on the fly from either interface 205/210 using the interface 206 as explained in the context of FIG. 3 below. Various elements of the server 204 may communicate in part or in whole via a wireless or hardwired communications link, such as Ethernet, IEEE 802.11b wireless, or the like.

Ad servers 228 provide advertising related to the errand and/or the location where the errand can be performed. For example, the user may receive contextual advertisements from the ad servers 228 such as ads for a nearby store, a particular event, a product in a nearby shop, and the like. The contextual advertisement may be presented on the interfaces 205/210 in ad areas such as ads 207/209. For example, the ad severe 228 accesses the user's data and user's task/errand history, and presents a targeted ad on the interfaces 205/210 based on the user's preferences.

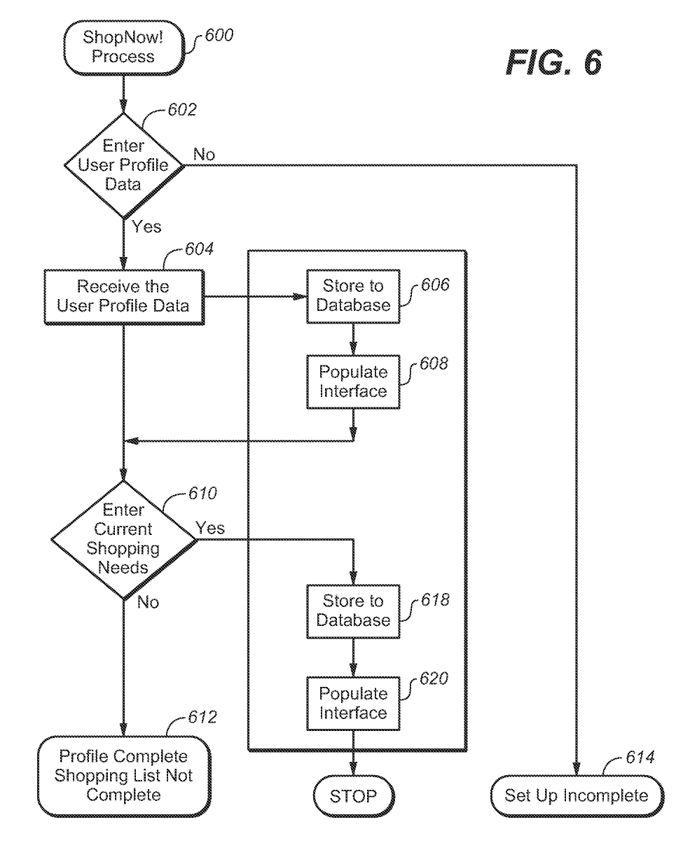

The rendering engine 230 collates information from these sources (e.g., Local Media Content module 220, task schedule module 222, and local context 208) and presents them on the clients 202/203. Data flows to the clients 202/203 from the server 204, and from the clients 202/203 to the server 204. For example, the GPS information from the clients 202/203 tells the system 200 where the user is, and using time stamps can tell what the user's trajectory and speed are. The algorithms (not shown in FIG. 2) lie between the general data sources in the Local Media Content module 220 and the user data (such as profile data and current needs as explained below in the context of FIG. 6), in the task schedule module 222, in the form of filters on the general data sources. The algorithms operate to present only the currently relevant information in combination with the user's preferences and current needs. The user data in effect is a filter over all the information that is available.

Exploiting the user's current location, temporal context and social context in concert with user generated information enables filtering of content for more targeted presentation. This is potentially important computationally; the resultant varied pacing—slow changing data from the user, potentially fast changing data from the device—offers more temporal slack in the derivation of user and context appropriate content, especially if regular routes and tasks are recorded (e.g., always commute along this route, buy tissues every three months, etc). Together these provide context (e.g., person's intent, location and amenities) for recommendations. The tasks, schedule/calendar, preferred retailers, location/place, trajectory, time, retailer addresses, products, maps/routing, local conditions (e.g., traffic plus weather), and/or other data are used to produce the context relevant recommendations. FIG. 3 is an illustration of an exemplary location-based opportunistic errand handling and targeted shopping recommendations user interface 300 according to an embodiment of the invention. FIG. 3 shows an example webpage desktop interface of interface 300 (also see user interface 206 in FIG. 2). The user interface 300 is generated using one or more computers, servers, workstations, or other data gathering, processing, computing and reporting systems. For example, server 204 could provide the data storage, record keeping and retrieval capabilities for the interface 300, and may include one or more databases to store the various data and other information used in the location-based opportunistic errand handling and targeted shopping recommendations system 200 (see FIG. 2). Data storage can be across any physical or logical data storage architecture, and any of a number of database models can be implemented. In one embodiment, a relational database structure is used to facilitate creation of responses from various separate sources of data. The interface 300 comprises a header 302, an Add Errand button 303, a Map Errand button 304, a calendar 306, a location map 308, a Register device interface 310, a Search Errands dialogue box 312, a recommendation tickertape 314, and an errand list 316.

The header 302 identifies the service provider. The branding (Yahoo!) is shown in the header 302 at the top of the interface 300. The header 302 may include a trademark or an explanation of services. The header 302 may also identify the user, and provide other service options.

Activating or clicking on the Add Errand button 303 opens a page or actionable fields (e.g., a fill-in form) into which users can enter errands that are upcoming, specifying the errand, a deadline or date by which it should be done, shops at which the errand can be achieved, a priority level for the errands and contacts with whom one might share errands (e.g., people often ask others in their family and friends circle to “pick things up” for them.). Tasks (errands) may be shared by the users (e.g., community, individuals, dyads, small and large groups). The errand is added to the errand list 316, which is a scrollable list of all errands that are currently to be done.

Activating or clicking on the Map Errands button 304 causes the errands in the errand list 316 to be placed on the calendar 306 and map 308, and highlights the errands and the calendar events that can be achieved today on map 308. The errands are placed on the calendar 306 which may also contain other activities—and which can be used to plan the user's errands as explained in more detail in the context of FIG. 6 below. For example, the calendar may contain “Meet Sally in Santa Clara”, and errands may need to be done at Macy's. Highlighting an errand may result in highlighting the outlets in the user's current location on the map 308 (as denoted by their current device location), or a location as shown on the calendar 306.

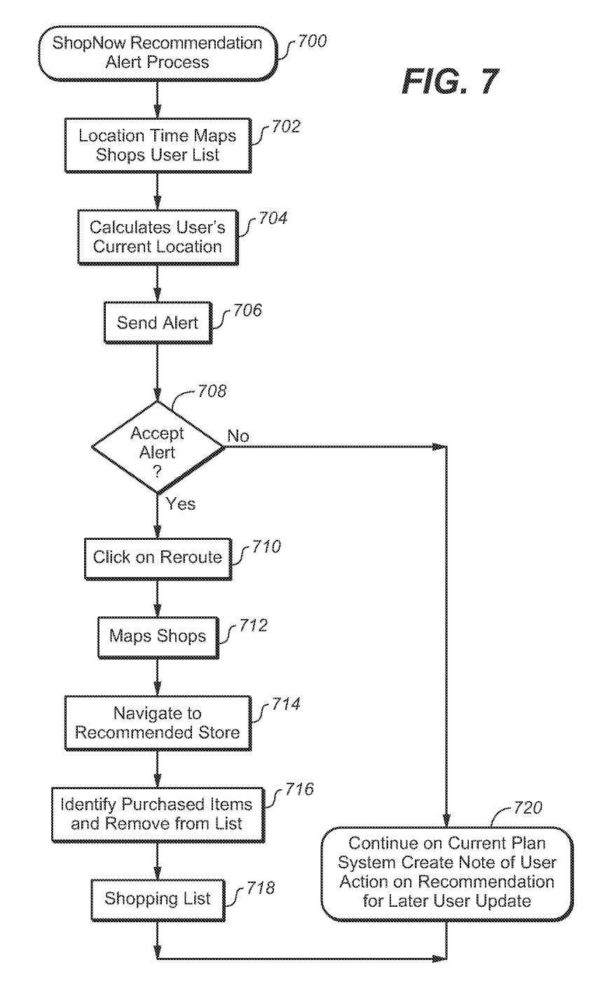

The Register Device interface 310 can be used by the users to specify the mobile device(s) to which alerts can be sent as explained in more detail in the context of FIG. 7 below, and which devices should be tracked.

The Search Errands dialogue box 312 allows users to search errands that have been carried out previously as well as currently open ones. Thereby, successful shopping trips can be repeated if the user would like to revisit a new venue that was previously unknown to the user when recommended by the system. FIG. 3B shows an interface for a particular errand/task.

Having filled out fields such as the Register Device interface 310 and Search Errands dialogue box 312, users can plan errand routes at the desktop and/or receive alerts when they are idle. A user can also actively “replan” his or her errand route from a mobile device. If the user accepts the alert then the user is rerouted by clicking the reroute buttons 213/215.

The recommendation tickertape 314 draws from the errand list, and suggests targeted marketing information to users, online and offline retailers who also may be offering the item listed in the errand. Simple information can also be placed here, such as: information about post office opening hours in the local area, a sale at the flower mart three miles from the user's house, a new cake-shop opening in the neighborhood, and so on. The information may scroll across the interface 300.

The errand list 316 of the user interface 300 (or the user interface 206 in FIG. 2) is operable to manage user errands that may be stored on task schedule module 222 (see FIG. 2). Each errand in the errand list 316 comprises an errand entry page that includes several data components (fields). These data components are shown in the interface 300 as the following columns: a priority of the errand 318, a description of the errand 320, a shop where the errand may be performed 322, an expected completion date 324 when the task needs to be completed, and whether the task is a shared task 326.

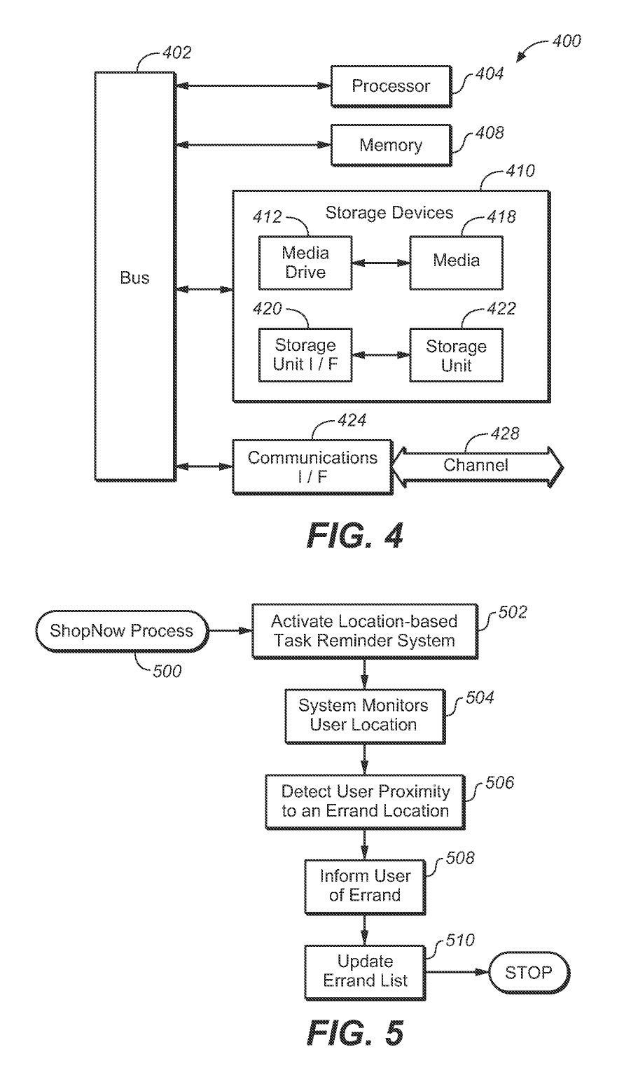

FIG. 4 illustrates a typical computing system 400 that may be employed to implement processing functionality in embodiments of the invention. For example, computing system 400 of this type may be used in clients and servers. Those skilled in the relevant art will also recognize how to implement the invention using other computer systems or architectures. Computing system 400 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 400 can include one or more processors, such as a processor 404. Processor 404 can be implemented using a general or special purpose processing engine such as, for example, a microprocessor, microcontroller or other control logic. In this example, processor 404 is connected to a bus 402 or other communication medium.

Computing system 400 can also include a main memory 408, such as random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (“ROM”) or other static storage device coupled to bus 402 for storing static information and instructions for processor 404.

The computing system 400 may also include information storage system 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 418 may include, for example, a hard disk, floppy disk, magnetic tape, optical disk, CD or DVD, or other fixed or removable medium that is read by and written to by media drive 412. As these examples illustrate, the storage media 418 may include a computer-readable storage medium having stored therein particular computer software or data.

In alternative embodiments, information storage devices 410 may include other similar components for allowing computer programs or other instructions or data to be loaded into computing system 400. Such components may include, for example, a removable storage unit 422 and a storage unit interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a USB port), a PCMCIA slot and card, etc. Software and data transferred via communications interface 424 are in the form of signals which can be electronic, electromagnetic, optical, or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels 428 to perform features or functions of embodiments of the invention. Note that the code may directly cause the processor to perform specified operations, be compiled to do so, and/or be combined with other software, hardware, and/or firmware elements (e.g., libraries for performing standard functions) to do so.

FIG. 5 shows an exemplary flow diagram illustrating a location-based task reminder process 500 according to an embodiment of the invention. The various tasks performed in connection with process 500 may be performed by software, hardware, firmware, a computer-readable medium having computer executable instructions for performing the process method, or any combination thereof. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. For illustrative purposes, the following description of process 500 may refer to elements mentioned above in connection with FIGS. 2-4. In various embodiments, portions of process 500 may be performed by different elements of systems 200-400 and in, e.g., clients, server, and the user interfaces.

A user may find he or she has extra time available and decides to activate the location-based opportunistic errand handling and targeted shopping recommendations system 200. For a first example, in traffic driving south on highway 280, Mindy gets stuck in traffic. She hears on the radio that a big-rig has overturned at the junction of highway 380, and that the traffic is unlikely to move for some time as emergency vehicles make their way to the scene. As a second example, Felix is waiting for the Muni at the J-Church Muni stop while headed home from work. He has promised to cook dinner for his partner's birthday and has carefully planned the shopping list and the menu for the evening. Checking the Muni schedule he sees the next tram is delayed by some time. As a third example, Elizabeth has arrived at Heathrow airport from San Francisco to discover her ongoing flight is delayed by several hours. The user directly or indirectly activates the location-based task reminder system 200 service. This may be done by activating a personal device such as a cell phone, computer, or PDA.

Process 500 may begin in response to the location-based opportunistic errand handling and targeted shopping recommendations system 200 receiving a request for service and activating the system 200 (task 502). This request may be via the internet, wirelessly, or via other means known by a person of ordinary skill in the art. For the first example, having been stationary for 10 minutes on a freeway with non-stationary traffic, Mindy's mobile alerts her. For the second example, concerned that he will reach his neighborhood too late to pick up some essentials and unfamiliar with local stores, Felix opens the application where he has stored his shopping list and other errands, and presses “Replan”. For the third example, while sitting in the waiting room, Elizabeth turns on her mobile phone to make a call to let her friends know she will be delayed by some hours in arriving at her final destination. As she completes the call, Elizabeth gets a notification from the system 200 as explained in more detail in the context of FIG. 7 below.

The location-based opportunistic errand handling and targeted shopping recommendations system 200 monitors the location of the user (task 504). This may be done via GPS, cellular triangulation, or the like. The system 200 may then detect proximity of a current location of the user to an errand location in an errand database (task 506). This may be done by comparing the user location to the coordinates stored in a database of stores or other locations were the errand may be performed. The system 200 informs the user of a task that may be performed (task 508). This may be via the internet, wirelessly, or the like. For the first example, Mindy is notified that there is a store in a nearby mall which she can reach by taking the next junction off the highway, and that she has a task that she can accomplish there. For the second example, the system 200 searches for local vendors based on his current location that he can walk to and buy his groceries. For the third example, Elizabeth is informed that there is a Body Shop cosmetics store in the Terminal, and that one of the items on her shopping list may be available at the store. The user may request additional information. For the third example, Elizabeth clicks “More” button to find out exactly where the store is. A scrollable map of the area is shown, showing her location and that of the store.

The user then performs the task. For the first example, Mindy crosses the lanes and leaves the highway to head to Target and get her errand done. For the second example, Felix checks the suggestions, and the timing of the Muni delay, and heads to the local stores. For the third example, Elizabeth proceeds to the store, makes her purchase and removes the item from her shopping list. In response to completion of the task, the system 200 may update the task reminder database (task 510). The update may be done through the interface 205/210 on user device 202/203. For the third example, while she is there, Elizabeth notes there are a couple of other items she may like to purchase in future—she adds them to her shopping wish list for later purchase (e.g., as explained in more detail in the context of FIG. 6 below).

FIG. 6 shows an exemplary flow diagram illustrating a process for entering shopping needs in a database by a user in accordance with an embodiment of the invention. The various tasks performed in connection with process 600 may be performed by software, hardware, firmware, a computer-readable medium having computer executable instructions for performing the process method, or any combination thereof. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. For illustrative purposes, the following description of process 600 may refer to elements mentioned above in connection with FIGS. 2-5. In various embodiments, portions of process 600 may be performed by different elements of systems 200-400, e.g., clients, server, and user interfaces.

Process 600 may begin by inquiring if a user wants to enter profile data into the database (inquiry task 602). If the user does not enter the profile data (No branch of inquiry task 602), the set up remains incomplete (task 614). However, if the user enters her/his profile data (Yes breach of inquiry task 602), process 600 receives the profile data (task 604), stores it in a database (task 606), and populates an interface with the profile data (task 608). The profile data may include, without limitation, a user ID, forms, preferred shops, device registry, preferences for times alerts, and sharing friends with whom the user wants to share shopping data, and the like. The user may then enter a current shopping need into the database (inquiry task 610). The current shopping need may include, without limitation, errands/tasks and their associated deadlines, time frames, shops, collaborators, users who can also complete the task, products and the like. Process 600 then stores the data pertaining to the current shopping need in the database (task 618), populates the interface with the information pertaining to the current shopping needs (task 620), and stops. However if the user does not enter the current shopping need (inquiry task 610), then process 600 ends with a completed profile and an incomplete current shopping list (task 612).

FIG. 7 shows an exemplary flow diagram illustrating a recommendation alert process in accordance with an embodiment of the invention. The location-based task reminder system described here combines people's knowledge of places and tasks. Tasks can only be associated with places that individuals personally entered. The place-task association is manually entered by a user. Reminders are based on virtual fencing techniques such as “geo-fences” where notification is given when a GPS device crosses a GPS coordinate described boundary. The various tasks performed in connection with process 700 may be performed by software, hardware, firmware, a computer-readable medium having computer executable instructions for performing the process method, or any combination thereof. It should be appreciated that process 700 may include any number of additional or alternative tasks, the tasks shown in FIG. 7 need not be performed in the illustrated order, and process 700 may be incorporated into a more comprehensive procedure or process having additional functionality not described in detail herein. For illustrative purposes, the following description of process 700 may refer to elements mentioned above in connection with FIGS. 2-6. In various embodiments, portions of process 700 may be performed by different elements of systems 200-400, e.g., clients, server, and user interfaces.

Process 700 may start by accessing a context database (task 702) (for example located in the task schedule module 222 of FIG. 2). The context data base may include, without limitation, location (i.e., GPS coordinates), time, maps, calendar items, shops and user's defined lists. Process 700 then calculates the current location of the user device based on GPS coordinates or other location detection methods known to those skilled in the relevant art, and the user's trajectory based on the user's preferences (task 704) and sends a shop now alert signal to the user device (task 706). If the user does not accept the alert (No branch of inquiry task 708), then process 700 proceeds to learn the user's preferences (task 720) where process 700 continues on a current plan and creates notes of users' actions on recommendation for later user profile updates. Thereby, successful shopping trips can be repeated if the user would like to revisit a new venue that was previously unknown to the user when recommended by the system. However, if the user accepts the alert (Yes branch of inquiry task 708), then the user is rerouted by clicking the “reroute” buttons 213/215. The user then accesses the maps (e.g., from internet sources) and location of the shops (e.g., from internet sources) in a database (task 712) to determine the route from the user's device current location to that of the recommended retailer(s), and navigates to recommended stores (task 714). The user then identifies purchased items (716), and updates the shopping list database (task 718) by removing the purchased items from the shopping list. Process 700 then continues to learn the users' preferences (task 720).

In this manner, user location sensing is combined with knowledge of tasks and user time management from explicit preference setting and/or from inference based on routine/usual user activities and of listed retail outlets in the area. The capability offers opportunistic location based route planning, and although embodiments of the invention have been described in the context of errand handling, there are a number of related applications that combine information on local area amenities, route planning and local conditions (e.g., traffic, weather).

The proposed application/service disclosed in the various embodiments of the invention recommends errands that can be done based on current location and travel context. People can therefore re-plan errand handling on-the-fly, taking advantage of current location, and local services (e.g., retail outlets) and amenities. Embodiments of the invention combine geo-location data, local shopping information, traffic and public transportation information (when relevant), and personal errand lists to make the most suitable recommendation. Embodiments of the invention disclose combinations of user-generated content (e.g., errands, tasks, dates, and social contacts) and data gathered from location-based devices and services to provide a powerful human-system, mutually reinforcing, collaborative filtering system which can provide relevant and desired information to users as well as supplemental information such as contextual advertisement. The contextual advertisements may be, for example, ads for a nearby store, a particular product in the nearby store, a coupon provided by a supermarket nearby, and the like.

Among other things, the system provides to users time and place context relevant reminding combined with on-the-fly route planning; powerful combination of different content sources, reducing need to seek, search, find and integrate the relevant information—reducing a user's cognitive load and effort; and opportunistic reuse of “down” time; and discovery of previously unknown venues.

Additionally, to system and service providers, the following are provided, but not limited to: in-context shopping recommendations for increased advertising effectiveness; taking deeper advantage of mobile capabilities, including combination of richer desktop to mobile experience; and richer user data for user modeling for more effective content match and experience provisions.

Although embodiments of the invention are described herein in terms of shopping, it should be understood that the present disclosure is not limited to shopping, but is generally applicable to community communication, communication between individuals, dyads, small groups (e.g., families) and large groups all being able to share tasks (aka errands). Furthermore, although the present disclosure has been fully described in connection with embodiments thereof with reference to the accompanying drawings, it is to be noted that various changes and modifications will become apparent to those skilled in the art. Such changes and modifications are to be understood as being included within the scope of the present disclosure as defined by the appended claims.

While various embodiments of the invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skilled in the art, two or more modules may be combined to form a single module that performs the associated functions according embodiments of the invention.

In this document, the terms “computer program product”, “computer-readable medium”, and the like may be used generally to refer to media such as, for example, memory 408, storage devices 410, or storage unit 422. These and other forms of computer-readable media may be involved in storing one or more instructions for use by processor 404 to cause the processor 404 to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all operable in a common package. Indeed, any or all of the various components of a module, whether control logic or other components, can be combined in a single package or separately maintained and can further be distributed across multiple locations.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements or controllers may be performed by the same processing logic element or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A location-based opportunistic task recommendations system, the system comprising:
a database of errands for storing errands intended to be performed by at least one user from a plurality of users; and
a server for sending an errand recommendation to at least one user device from a plurality of user devices in response to the at least one user device being in a suitable proximity to a location where and when an errand can be performed.

2. The system of claim 1, further comprising logic for updating the database of errands in response to completion of the errand.

3. The system of claim 1, further comprising a first advertising server for providing advertising related to the errand.

4. The system of claim 1, further comprising a second advertising server for providing advertising related to the location where and when the errand can be performed.

5. The system of claim 1, wherein the suitable proximity is based on a location and current trajectory of the at least one user.

6. The system of claim 1, further comprising a local media content module operable for accessing a plurality of data sources.

7. The system of claim 1, wherein the users comprise family members, groups, individuals, and community members.

8. The system of claim 1, wherein the errand is a sharable errand.

9. The system of claim 8, wherein the errand in shared by the plurality of the users.

10. The system of claim 1, further comprising logic for providing an interface for presentation on a display, wherein the interface comprises:
a listing of sharable errands operable for management of the listing of sharable errands; and
a device registration interface operable for specifying that the at least one user device is to be tracked.

11. The system of claim 10, wherein the plurality of users devices comprises devices that are used by family members, groups, individuals, and community members.

12. The system of claim 10, wherein the errand is a sharable errand.

13. The system of claim 10, wherein errands are shared by the plurality of the users.

14. A method for location-based opportunistic task recommendations, the method comprising:
obtaining a current location of at least one user device from a plurality of user devices;
detecting proximity of the current location of the at least one user device to an errand location in an errand database; and
notifying the at least one user device of an errand that can be performed at the current location.

15. The method of claim 14, further comprising updating the errand database in response to an errand being performed.

16. The method of claim 14, further comprising providing advertising related to the errand.

17. The method of claim 14, further comprising providing advertising related to a location where and when an errand can be performed.

18. The method of claim 14, wherein the step of detecting proximity is further based on a current trajectory of the at least one user device.

19. The method of claim 14, further comprising storing the errand in the errand database.

20. The method of claim 14, further comprising matching the errand to the current location and time.

21. The method of claim 14, further comprises determining a route from the current location to a new location where the errand can be performed.

22. A computer-readable medium comprising program code for providing location-based opportunistic task recommendations, the program code for:
obtaining a current location of at least one user device;
obtaining a current time;
detecting proximity of the current location of the at least one user device to an errand location in an errand database; and
notifying the at least one user device of an errand that can be performed at the current location and the current time.

23. The computer-readable medium of claim 22, further comprising program code for updating the errand database in response to an errand being performed.

24. The computer-readable medium of claim 22, further comprising program code for providing advertising related to an errand.

25. The computer-readable medium of claim 22, further comprising program code for providing advertising related to a location where and when an errand can be performed.

26. The computer-readable medium of claim 22, wherein the step of detecting proximity is further based on a current trajectory of the at least one user device.

27. The computer-readable medium of claim 22, further comprising program code for storing an errand in the errand database.

28. The computer-readable medium of claim 22, further comprising program code for determining a route from the current location to a new location where the errand can be performed.

29. An interface for providing task recommendations, the interface comprising:
a listing of at least one errand operable for management of the listing of at least one errand; and
a device registration interface operable for enabling at least one user device to receive notification of the at least one errand that can be done at a location of the at least one user device.

30. The interface of claim 29, wherein the at least one device is a mobile device.

31. The interface of claim 29, further comprising an add errand button operable to receive data for an errand and add the data for the errand to the listing of errands.

32. The interface of claim 29, further comprising a map errand button operable to indicate a location of an errand on at least one of a map or a calendar.

33. The interface of claim 29, further comprising a search errands dialogue box operable to search for errands in the list of errands.

34. The interface of claim 29, further comprising a recommendation tickertape operable to provide a tickertape of errand recommendations.

35. The interface of claim 29, wherein the device registration interface is further operable for enabling the user device to use the interface.

36. The interface of claim 29, further comprising a reroute button operable to reroute the at least one user device to a new location where the at least one errand can be performed.
